(19) United States
(12) Patent Application Publication
(10) Pub. No.: US 2007/0106877 A1
(43) Pub. Date: May 10, 2007

(54) Single-chip multiple-microcontroller architecture and timing control method for the same

(76) Inventors: Tsan-Bih Tang, Hsin-Chu (TW); Jung-Lin Chang, Hsin-Chu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/270,574

(22) Filed: Nov. 10, 2005

(51) Int. Cl. G06F 9/40

(52) U.S. Cl. 712/205

(57) ABSTRACT

A single-chip multiple-microcontroller architecture and a timing control method for the same are proposed. The single-chip multiple-microcontroller architecture comprises multiple microcontrollers integrated into a single chip. Different microcontrollers are separately executed at mutually exclusive timings, equivalent to several microcontrollers that operate parallel and independently. Therefore, multiple microcontrollers can be realized in a single IC chip to accomplish the effect of parallel processing.

### BACKGROUND OF THE INVENTION

1. Field of the Invention

The present invention relates to a multiple-microcontroller architecture and a timing control method for the same and, more particularly, to a multiple-microcontroller architecture integrated into a single chip and a timing control method for the same.

2. Description of Related Art

As shown in FIG. 1, a conventional single-chip microcontroller 10 comprises a microcontroller core logic 11, a program memory 12, and a data memory 13. The microcontroller core logic 11 reads program codes stored in the program memory 12 via a program memory bus 112. The data memory 13 is connected to the microcontroller core logic 11 via a data memory bus 113 for transmission of data and its size will depend on the system specification. Besides, different peripheral control bus 114 may be required when the microcontroller 10 is cooperated with different peripheral devices 14. A microcontroller system needs to stop the currently executed program and perform an interrupt service whenever there is interrupt request. Due to the variation of the interrupt timing point, the order and timing of program execution will be changed and thus cannot be accurately predicted when there is an interrupt event in the program. For some peripheral devices, precise and fixed timing is required to make devices operated well. In such cases, it is difficult to emulate the handshaking protocol by using software. Moreover, it's also hard to measure the timing of signals precisely in this situation.

FIG. 2 is the block diagram of a conventional multiple-microcontroller architecture. Microcontroller 26, 27 and 28 are composed of program memories 261, 271 and 281 and microcontroller core logic 262, 272 and 282, respectively. The microcontroller 26, 27 and 28 form a so-called multiple-microcontroller via bus, a shared data memory 23 and a shared peripheral device 24. The number of microcontroller (26, 27 and 28) depends on the desired system specification. Because every microcontroller core logic (262, 272 and 282) has its own program memory (261, 271 and 281), each microcontroller (26, 27 or 28) can operate independently. Each microcontroller (26, 27 or 28) can have its own operating clock. The disadvantage of this architecture is that the microcontroller 26, 27 and 28 will interfere one another when accessing the shared data memory 23 or the shared peripheral device 24. In addition to interference each other, the program development of system will become complicated because the program memories 261, 271 and 281 are not shared.

Presently memory can support higher and higher bandwidth, a super-scalar/hyper-thread multiple-microcontroller architecture has been proposed, as shown in FIG. 3. Microcontroller core logic 32,34 share a program memory 30 and can operate together. To reduce the interference each other, instruction buffers 321, 341 are added between the microcontroller core logic 32, 34 and the program memory 30, respectively. Because each microcontroller core logic (32, 34) has its own instruction buffer (321, 341), the probability of reading the program memory 30 from the microcontroller core logic 32 and 34 is decreased, thus the probability of mutual interference between different microcontroller is also reduced. This architecture, however, can only reduce the occurrence probability instead of totally avoiding mutual interference between microcontrollers, and the writing of program is still complicated. It is difficult to realize this multiple-microcontroller architecture in a single-chip.

Accordingly, the present invention aims to propose a single-chip multiple-microcontroller architecture and a timing control method for the same, in which all microcontrollers in a single chip share a program memory. In addition to reducing the manufacturing cost, the problem of mutual interference between microcontrollers can be effectively solved, hence accomplishing a real parallel processing architecture.

### SUMMARY OF THE INVENTION

An object of the present invention is to provide a single-chip multiple-microcontroller architecture and a timing control method for the same, in which several microcontrollers share a program memory to effectively avoid mutual interference of program execution of the microcontrollers and simplify the development of program, thus reducing the product developing cost.

Another object of the present invention is to provide a single-chip multiple-microcontroller architecture and a timing control method for the same, in which different microcontrollers operate at mutually exclusive timings so that several microcontrollers can operate parallel and independently. Several programs can therefore be processed in a parallel way to enhance the efficiency.

According to the present invention, a single-chip multiple-microcontroller architecture comprises multiple microcontroller core logics each capable of executing at least a program, a timing control logic connected to the microcontroller core logics and used to provide mutually exclusive timings for separate execution of each microcontroller core logic, and a program memory control logic connected to the microcontroller core logics and a program memory. The program memory control logic reads stored program codes from program memory corresponding to each of microcontroller core logics. Because these microcontroller core logics share the same program memory and each of microcontroller core logic separately executes the corresponding program in a different timing, mutual interference can be effectively avoided, and several programs can be simultaneously executed, thus enhancing the efficiency.

The present invention also provides a timing control method of a single-chip multiple-microcontroller architecture. The single-chip multiple-microcontroller comprises X microcontrollers, where X≧2. The system provides a basic operating clock of frequency F. These X microcontrollers are driven to operate under operating clocks with frequencies F1, F2, . . . , FX, respectively. All of F1, F2, . . . , FX are smaller than F, and satisfy the inequality: F1+F2 +. . . +FX≦F.

### BRIEF DESCRIPTION OF THE DRAWINGS

The various objects and advantages of the present invention will be more readily understood from the following detailed description when read in conjunction with the appended drawing, in which:

FIG. 1 is a block diagram of a conventional single-chip microcontroller architecture;

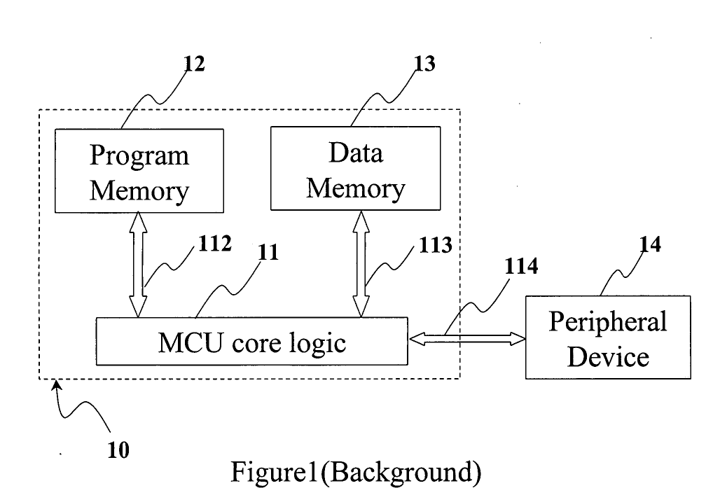

FIG. 2 is a block diagram of a conventional multiple-microcontroller architecture;

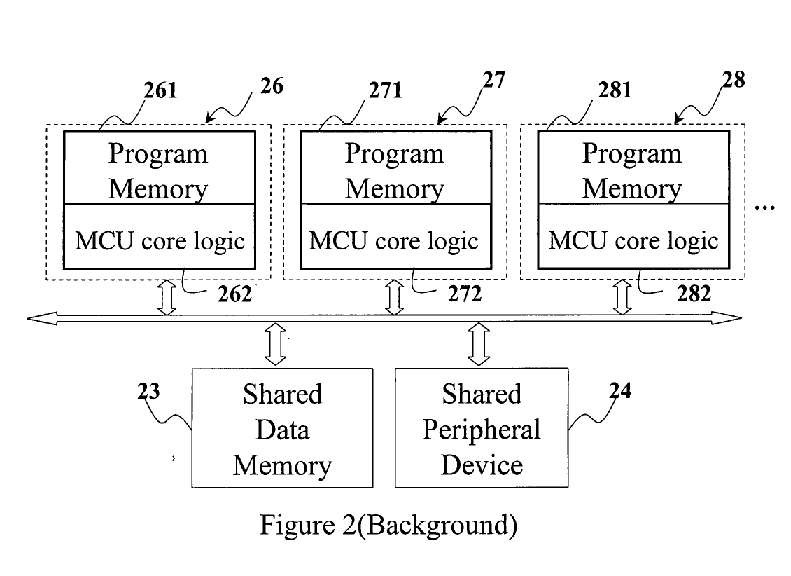

FIG. 3 is a block diagram of another conventional multiple-microcontroller architecture;

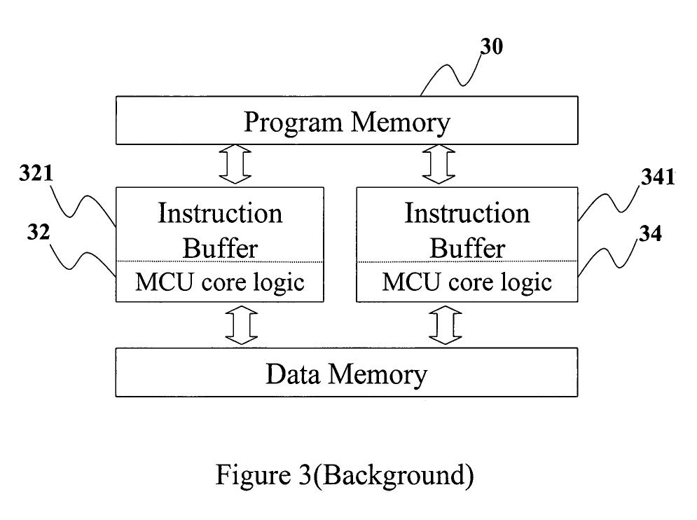

FIG. 4 is a block diagram according to an embodiment of the present invention; and

FIG. 5 is a timing diagram of the present invention exemplified with four microcontrollers.

### DETAILED DESCRIPTION OF THE PREFERRED EMBODIMENTS

The present invention provides a single-chip multiple-microcontroller architecture, which realizes several microcontrollers on a single IC chip. These microcontrollers share a program memory. Every microcontroller can execute its own program without mutual interference. Moreover, the program execution of every microcontroller is in parallel way, and thus the program development can be simplified.

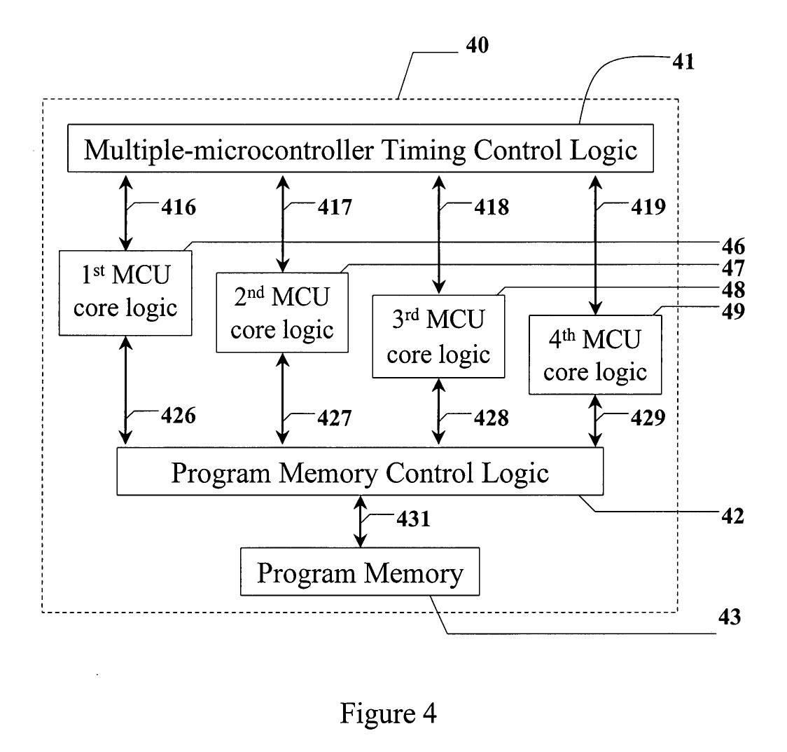

As shown in FIG. 4, a single-chip multiple-microcontroller 40 comprises X microcontrollers capable of operating independently. In this embodiment, the single-chip multiple-microcontroller 40 comprises four microcontroller core logics 46, 47, 48 and 49. The first microcontroller core logic 46 is used to execute a main program. The second microcontroller core logic 47 is used to generate pulse width modulation (PWM) waveforms. The third microcontroller core logic 48 is used to execute serial peripheral interface (SPI). The fourth microcontroller core logic 49 is used to execute inter-IC (I²C) handshaking protocol. Each of the microcontroller core logic 46, 47, 48 and 49 can execute at least a program. The timing of the microcontroller core logics 46, 47, 48 and 49 is controlled by a multiple-microcontroller timing control logic 41 connected therewith so that the microcontroller core logics 46, 47, 48 and 49 can have their own respective timing control signals 416, 417, 418 and 419. The microcontroller core logics 46, 47, 48 and 49 can execute their own programs at mutually exclusive timings. With different timing control signals 416, 417, 418 and 419, the microcontroller core logics 46, 47, 48 and 49 will send out corresponding program memory control signals 426, 427, 428 and 429 to a program memory control logic 42 to fetch corresponding program codes, respectively. Receiving the program memory control signals 426, 427, 428 and 429, the program memory control logic 42 then sends out a program memory control signal 431 to a program memory 43. Because the program memory 43 stores programs executed by the microcontroller core logics 46, 47, 48 and 49, the program memory control logic 42 can use the program memory control signal 431 to read the required program from the program memory 43, and transmit in order the required program codes back to the microcontroller core logics 46, 47, 48 and 49 according to different timings of the microcontroller core logics 46, 47, 48 and 49.

In the abovementioned architecture, the microcontroller core logic 46, 47, 48 and 49 dynamically share the program memory control logic 42 and program memory 43. Combining with the program memory control logic 42 and program memory 43, each of the microcontroller core logic 46, 47, 48 and 49 dynamically constitute a complete and fully-functional microcontroller.

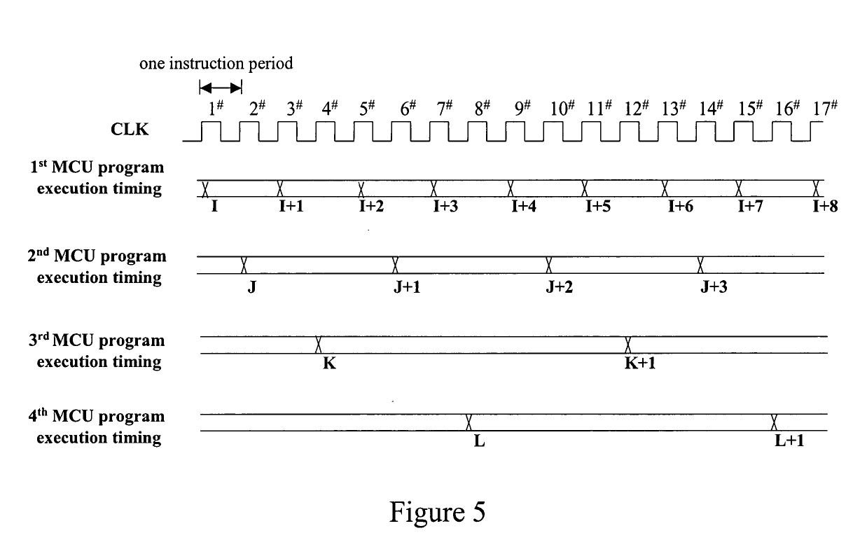

FIG. 5 is a timing diagram of the present invention exemplified with four microcontrollers. Reference is made to FIG. 4 as well as FIG. 5. On the timing 1# of the clock CLK, the multiple-microcontroller timing control logic 41 outputs a corresponding first microcontroller timing control signal 416 to the first microcontroller core logic 46 to execute the (I)th operation of the main program. On the timing 2# of the clock CLK, the multiple-microcontroller timing control logic 41 outputs a corresponding second microcontroller timing control signal 417 to the second microcontroller core logic 47 to execute the (J)th operation of PWM function. On the timing 3# of the clock CLK, the multiple-microcontroller timing control logic 41 outputs a corresponding first microcontroller timing control signal 416 to the first microcontroller core logic 46 to execute the (I+1)th operation of the main program. On the timing 4# of the clock CLK, the multiple-microcontroller timing control logic 41 outputs a corresponding third microcontroller timing control signal 418 to the third microcontroller core logic 48 to execute the (K)th operation of SPI function. On the timing 5# of the clock CLK, the multiple-microcontroller timing control logic 41 outputs a corresponding first microcontroller timing control signal 416 to the first microcontroller core logic 46 to execute the (I+2)th operation of the main program. On the timing 6# of the clock CLK, the multiple-microcontroller timing control logic 41 outputs a corresponding second microcontroller timing control signal 417 to the second microcontroller core logic 47 to execute the (J+1)th operation of PWM function. On the timing 7# of the clock CLK, the multiple-microcontroller timing control logic 41 outputs a corresponding first microcontroller timing control signal 416 to the first microcontroller core logic 46 to execute the (I+3)th operation of the main program. On the timing 8# of the clock CLK, the multiple-microcontroller timing control logic 41 outputs a corresponding fourth microcontroller timing control signal 419 to the fourth microcontroller core logic 49 to execute the (L)th operation of I²C function. The relationship between the microcontroller timing control signals 416, 417, 418 and 419 and the corresponding microcontroller core logics 46, 47, 48 and 49 and the executed operations can be deduced by analogy.

Reference is made to FIGS. 4 and 5 again. Analysis will be made in the view of the execution clocks of the first microcontroller core logic 46, the second microcontroller core logic 47, the third microcontroller core logic 48 and the fourth microcontroller core logic 49, respectively. The clock of the multiple-microcontroller is CLK. The instruction execution time points of the first microcontroller core logic 46 include 1#, 3#, 5#, 7#, . . . and so on. The corresponding executed operations of the first microcontroller core logic 46 are the (I)th operation, (I+1)th operation, (I+2)th operation, (I+3)th operation, . . . and so on of the main program. The effective execution clock of the first microcontroller core logic 46 is a half of the clock of the multiple-microcontroller. Similarly, The instruction execution time points of the second microcontroller core logic 47 include 2#, 6#, 10#, 14#, . . . and so on. The corresponding executed operations of the second microcontroller core logic 47 are the (J)th operation, (J+1)th operation, (J+2)th operation, (J+3)th operation, . . . and so on of the PWM program. The effective execution clock of the second microcontroller core logic 47 is a quarter of the clock of the multiple-microcontroller. The instruction execution time points of the third microcontroller core logic 48 include 4#, 12#, 20#, . . . and so on, the corresponding executed operations of the third microcontroller core logic 48 are the (K)th operation, (K+1)th operation, (K+2)th operation, . . . and so on of the SPI program. The effective execution clock of the third microcontroller 48 is an eighth of the clock of the multiple-microcontroller. The instruction execution time points of the fourth microcontroller core logic 49 include 8#, 16#, 24#, . . . and so on, the corresponding executed operations of the fourth microcontroller core logic 49 are the (L)th operation, (L+1)th operation, (L+2)th operation, . . . and so on of the I²C program. The effective execution clock of the fourth microcontroller core logic 49 is an eighth of the clock of the multiple-microcontroller.

Moreover, reference is again made to FIG. 4 and FIG. 5. Because the first microcontroller core logic 46, the second microcontroller core logic 47, the third microcontroller core logic 48 and the fourth microcontroller core logic 49 are operated at mutually exclusive timings, they can share the program memory 43 without the need of adding an extra instruction buffer to reduce mutual interference between different microcontrollers, thus saving hardware cost and not increasing software complexity.

From the above illustrations, it is obvious the operating frequencies of the multiple-microcontrollers satisfy the following relation:
F1+F2+. . . +FX≦F (1)
where F is the frequency of the basic operating clock of a single-chip system having X microcontrollers, which operate under operating clocks of frequencies F1, F2, . . . , FX, respectively. All of F1, F2, . . . , FX are smaller than F.

In this embodiment, X=4. These four microcontrollers share the bandwidth resource with the operating frequencies F/2, F/4, F/8 and F/8, respectively. Of course, this is not the only manner, and the designer can distribute the bandwidth resource in an arbitrary way. For instance, these four microcontrollers can evenly share the bandwidth resource with the operating frequencies F/4, F/4, F/4 and F/4, respectively. It is also feasible to temporarily share no bandwidth resource to microcontrollers not in use in a dynamic way so as to share the bandwidth resource to other microcontrollers in use. For example, these four microcontrollers can share the bandwidth resource with the operating frequencies F/2, F/4, F/4 and 0.

The basic operating frequency F provided by the system is not only used to define the clock frequency originally provided by the system, but can also be used to define the smallest unit of operation of each instruction. For instance, when a double-frequency design is adopted for the circuit, if the circuit operates in both the positive half-cycle and the negative half-cycle of each clock period, then F is twice the clock frequency originally provided by the system. If the operating frequency is generated by the circuit, then the basic operating frequency of the clock is F. Speaking more specifically, if the clock originally provided by a system is 1 MHz and the system generates an operating frequency of 3 MHz, then the basic operating frequency F provided by the system is 3 MHz. In other words, the so-called F represents the actual operating frequency when the system operates.

Besides, different function combinations of multiple-microcontroller can be produced after execution timings of different microcontrollers are changed by the multiple-microcontroller timing control logic. Different timing controls should be matched based on specifications of various systems and peripheral devices. For example, a timing of higher frequency should be provided for a microcontroller responsible for processing faster handshaking protocol.

To sum up, a multiple-microcontroller timing control logic and a program memory control logic can be used to drive several microcontrollers to execute their own respective programs so as to effectively solve the problem of mutual interference in timing. Therefore, a single-chip multiple-microcontroller architecture capable of parallel processing can be accomplished, and several programs can be processed in a parallel way. Furthermore, the present invention makes use of several microcontrollers to share a program memory for reducing the hardware cost and the difficulty in software development.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

I claim:

1. A single-chip multiple-microcontroller architecture of comprising:
at least two microcontroller core logics each capable of executing at least a program parallel and independently;
a timing control logic connected to said microcontroller core logics and used to provide mutually exclusive timings for execution of said microcontroller core logics; and
a program memory control logic, one end of said program memory control logic being connected to said microcontroller core logics, the other end of said program memory control logic being connected to a program memory, said program memory control logic reading program codes in said program memory and providing said program codes for said microcontroller core logics at mutually exclusive timings.

2. The single-chip multiple-microcontroller architecture as claimed in claim 1, wherein said program memory is used to store all program codes required for execution of said microcontroller core logics.

3. The single-chip multiple-microcontroller architecture as claimed in claim 1, wherein a plurality of timing control buses is connected between said microcontroller core logics and said timing control logic to transmit signals.

4. The single-chip multiple-microcontroller architecture as claimed in claim 1, wherein a plurality of program memory control buses is connected between said microcontroller core logics and said program memory control logic to transmit signals.

5. The single-chip multiple-microcontroller architecture as claimed in claim 1, wherein a program memory bus is connected between said program memory and said program memory control logic to transmit signals.

6. A timing control method of a single-chip multiple-microcontroller, said single-chip multiple-microcontroller comprising X microcontrollers, where X≧2, and said single-chip multiple-microcontroller operating at a clock of frequency F, said method comprising the steps of:
driving said X microcontrollers to operate respectively under operating clocks of frequencies F1, F2, . . . , FX, all of F1, F2, . . . , FX being smaller than F; and
letting F1+F2+. . . +FX≦F.

7. The timing control method of a single-chip multiple-microcontroller as claimed in claim 6, wherein said X microcontrollers equally share the resource of clock, i.e., F1=F2=. . . =FX.

8. The timing control method of a single-chip multiple-microcontroller as claimed in claim 6, wherein when there are Y of said X microcontrollers that are not operating, the resource of clock is shared by (X−Y) microcontrollers, and F1+F2+. . . +F(X−Y) ≦F.
